(19) United States
(12) Patent Application Publication
(10) Pub. No.: US 2018/0068500 A1
(43) Pub. Date: Mar. 8, 2018

(54) SYSTEMS AND METHODS FOR AN AUTOMOTIVE TEMPERATURE WARNING DEVICE

(71) Applicant: ADVANCED AQUA GROUP, JACKSONVILLE, FL (US)

(72) Inventor: Kenneth Dekle Henson, Jacksonville, FL (US)

(21) Appl. No.: 15/696,842

(22) Filed: Sep. 6, 2017

Related U.S. Application Data
(60) Provisional application No. 62/384,009, filed on Sep. 6, 2016.

(51) Int. Cl. G07C 5/08; G07C 5/00; H04Q 9/00

(52) U.S. Cl. CPC G07C 5/0825; G07C 5/008; H04Q 2209/50; H04Q 2209/40; H04Q 2209/823; H04Q 9/00

(57) ABSTRACT

A system for monitoring the temperature of a vehicle includes a device body and a microprocessor housed in the device body. The system further includes a temperature sensor in the device body connected to the microprocessor. The system further includes a transmitter in the device body connected to the microprocessor, the microprocessor executing code to monitor ambient temperature with the temperature sensor and when the ambient temperature exceeds a preset level sending a message using the transmitter to a mobile electronic device.

### CROSS REFERENCE TO RELATED APPLICATIONS

This application claims the benefit of U.S. Provisional Application No. 62/384,009 filed on Sep. 6, 2016, which is incorporated herein by reference in its entirety.

### BACKGROUND

During warm weather months, the temperature in an automobile can rise rapidly if the vehicle ventilation system is not running. As such, it is very dangerous to leave animals, children, or other living things in a vehicle for even a short period of time. This an inconvenience for individuals and may be life threatening to children or animals.

### BRIEF SUMMARY

In one embodiment, a system for monitoring the temperature of a vehicle includes a device body and a microprocessor housed in the device body. The system further includes a temperature sensor in the device body connected to the microprocessor. The system further includes a transmitter in the device body connected to the microprocessor, the microprocessor executing code to monitor ambient temperature with the temperature sensor and when the ambient temperature exceeds a preset level sending a message using the transmitter to a mobile electronic device. Optionally, the transmitter utilizes Wi-Fi Direct protocol. Alternatively, the transmitter utilizes GSM protocol. In another alternative, the message is a text message. In one configuration, the mobile electronic device is a smart phone. Alternatively, comprising a battery located in the device body. Optionally, the system further includes a plug for interfacing with a power source of the vehicle, the power source providing for charging of the battery, the microprocessor executing instructions to control the charging of the battery. Alternatively, power source is a standard 12V vehicle receptacle.

In one embodiment, a system for monitoring the temperature of a vehicle includes a device that includes a device body and a microprocessor housed in the device body. The device further includes a temperature sensor in the device body connected to the microprocessor. The device further includes a transmitter in the device body connected to the microprocessor. The system further includes a mobile electronic device, the mobile electronic device communicating with the transmitter and microprocessor, the microprocessor executing code to monitor ambient temperature with the temperature sensor and when the ambient temperature exceeds a preset level sending a message using the transmitter to the mobile electronic device. In one alternative, the mobile electronic device is executing code enabling the mobile electronic device to configure the preset level via the transmitter. Alternatively, the mobile electronic device is executing code that mates the mobile electronic device to the device. In another alternative, the mating involves programming a phone number of the mobile electronic device in the device. In one configuration, the transmitter utilizes Wi-Fi Direct protocol. Optionally, the message is sent via Wi-Fi Direct protocol directly to the mobile electronic device and the mobile electronic device is executing code causing the mobile electronic device to produce a notification for the user based on receiving the message. Alternatively, the transmitter utilizes GSM protocol. In one configuration, the message is a text message. In another configuration, the mobile electronic device is a smart phone. Optionally, the device further includes a battery located in the device body. Optionally, the device further includes a plug for interfacing with a power source of the vehicle, the power source providing for charging of the battery, the microprocessor executing instructions to control the charging of the battery. In one alternative, the power source is a standard 12V vehicle receptacle.

### BRIEF DESCRIPTION OF THE DRAWINGS

FIG. 1 shows one embodiment of a system for monitoring vehicle temperature.

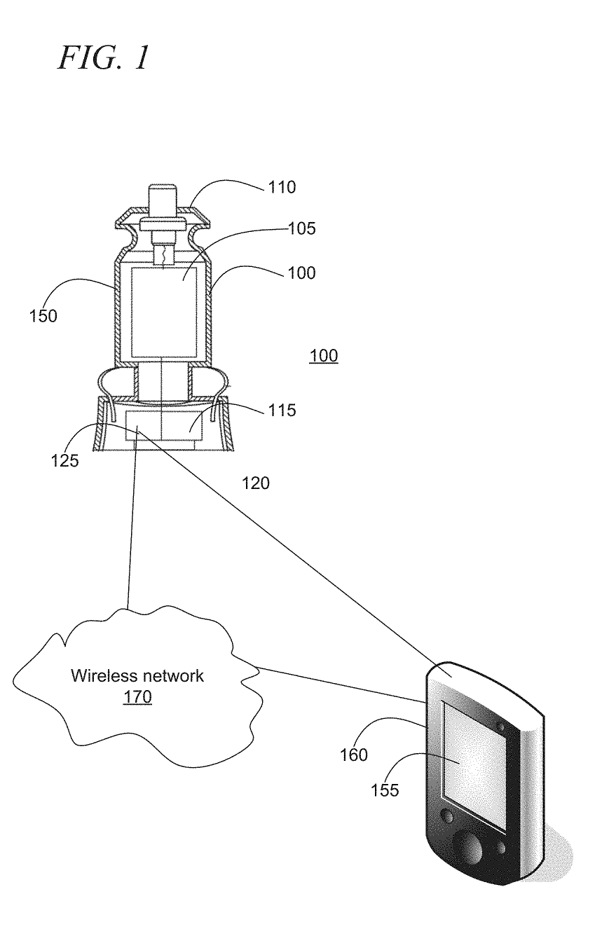

### DETAILED DESCRIPTION

Certain terminology is used herein for convenience only and is not to be taken as a limitation on the embodiments of the systems and methods for an automotive temperature warning device.

As noted above, rising temperatures in a vehicle may be a danger to animals and people left in the vehicle. This is especially true if the vehicle's ventilation system is not functioning. In many scenarios, a user may leave their vehicle running, with the intent to keep the vehicle cool while running a quick errand and leaving an animal in the vehicle. In some instances, the vehicle may stall or shut off, causing the vehicle temperature to rise quickly. Additionally, at times a vehicle may be left in an off condition while running an errand. If the time it takes to complete the errand is longer than an individual anticipates, the vehicle temperature may rise to an unsafe level.

Therefore, in one embodiment, a system for an automotive temperature warning device, may include a device insertable into the power socket of a vehicle. In this way, the device 100 is constantly charged when the vehicle runs which obviates the need to monitor the charge status of the device. In alternatives, the device may be simply a battery powered device that requires recharging or replacement of batteries from time to time. Device 100 includes a battery 105 that stores power for the device to function when the vehicle is not directly supplying power to device 100. In many embodiments, device 100 includes a 12 volt cigarette lighter plug 110. Various sizes and voltages of plugs may be used for plug 110, as well and a plug that adapts to:

6-volt cigarette lighter receptacle and plug—Receptacle inside diameter: 21.34-21.46 mm (median 21.4 mm)—Plug body diameter: 21.08-21.23 mm (median 21.155 mm)
12-volt cigarette lighter receptacle and plug, size A—Receptacle inside diameter: 20.93-21.01 mm (median 20.97 mm)—Plug body diameter: 20.73-20.88 mm (median 20.805 mm)
12-volt cigarette lighter receptacle and plug, size B—Receptacle inside diameter: 21.41-21.51 mm (median 21.455 mm)—Plug body diameter: 21.13-21.33 mm (median 21.18 mm)

Plug 110 is in electrical communication with battery 105 and provides for the charging of battery 105. Device 100 additionally includes microprocessor 115, temperature sensor 120, and transmitter 125. All of these systems are housed in low profile casing 150.

Essentially, device 100 executes an algorithm in microprocessor 115 that causes device 100 to monitor the ambient temperature with temperature sensor 120. When the ambient temperature reaches a certain level (80 degrees F. for example) the microprocessor will cause the device to send messages via a wireless network to a user a preset address. In many embodiments, the wireless network will be a cellular network such as a GSM, LTE, or other network. In many embodiments the notification may be a text message or an email. Additionally, the device may be programmed only to send a message if the device 100 also detects that it is not charging, suggesting that the vehicle is not running.

Additionally, an application 155 for the user's phone may be provided. The application for the user's phone will provided for the mating of the device 100 with a cellular phone 160. The application may provide for the programming of presets on the device 100 and may eliminate the need for device 100 to have any buttons or other inputs means, allowing it to remain small and low profile. In addition to having transmitter 125 provide for cellular network 170 such as a GSM, LTE, or other networks, the transmitter 125 may provide for Bluetooth or Bluetooth Low Energy communication. This interface may be the optimum interface for communication between the phone 160 and the device 100.

Application 155 may provide a graphical user interface 160, that allows for the programming of one or more telephone numbers for messaging as well as a preset for the temperature at which a notification is triggered. Application may include a menu driven system as part of GUI 160 that allows for the entering of text and the configuration of various features.

In operation, a user plugs device 100 into a power source of a vehicle. The device 100 automatically charges battery 105 when the vehicle is in operation. The microprocessor 115 executes an algorithm that monitors the ambient temperature using sensor 120. If the temperature goes above a preset, the microprocessor activates transmitter 125 and sends a text message or other message to the number of the preprogrammed cellular phone 160. Optionally, the message may include the temperature of the vehicle. Optionally, the message may include how long the vehicle has been above that temperature.

In many configurations, the system will utilize a GSM network to send the text message. Alternatively, various network types may be used. Optionally, instead of a text message, device 100 will interface directly with application 155 over a data network. In such a configuration device 100 will send periodic signals through a data network to application 155. If application 155 does not receive a signal for a preset period of time, it will notify the user that connection to device 100 has been lost. This is a signal to the user that the device 100 will no longer report the incidence of a temperature increase above the preset limit. Otherwise, this embodiment will monitor the temperature and notify the user if the temperature rises above the preset. This is typically done through communication over a data network. In many embodiments however, this type of network may be substituted with a Wi-FI Direct device to device connection. A Wi-Fi Direct system may be optimal, since the typically range of such a system is 50-100 meters. This is typically a safe distance for a user to be from the vehicle for purposes of temperature control. Also, Wi-Fi Direct does not require a wireless access point, it is merely a connection between device 100 and cellular phone 160. This obviates the need to acquire GSM network access as well. In such a configuration, the application 155 itself may still generate text messages internal that originate at the cellular phone in response to communication received over the WiFi direct network. In other configurations, the device 100 may use a variety of communication protocols to send messages, providing for redundancy which increases the reliability of the system.

Typically, the mobile electronic device is a smart phone executing Android operating instructions or that of the iPhone. Any mobile device that may be configured to perform the tasked described herein is possible.

In many embodiments, parts of the system are provided in devices including microprocessors. Various embodiments of the systems and methods described herein may be implemented fully or partially in software and/or firmware. This software and/or firmware may take the form of instructions contained in or on a non-transitory computer-readable storage medium. Those instructions then may be read and executed by one or more processors to enable performance of the operations described herein. The instructions may be in any suitable form such as, but not limited to, source code, compiled code, interpreted code, executable code, static code, dynamic code, and the like. Such a computer-readable medium may include any tangible non-transitory medium for storing information in a form readable by one or more computers such as, but not limited to, read only memory (ROM); random access memory (RAM); magnetic disk storage media; optical storage media; a flash memory, etc.

Embodiments of the systems and methods described herein may be implemented in a variety of systems including, but not limited to, smartphones, tablets, laptops, and combinations of computing devices and cloud computing resources. For instance, portions of the operations may occur in one device, and other operations may occur at a remote location, such as a remote server or servers. For instance, the collection of the data may occur at a smartphone, and the data analysis may occur at a server or in a cloud computing resource. Any single computing device or combination of computing devices may execute the methods described.

While specific embodiments have been described in detail in the foregoing detailed description, it will be appreciated by those skilled in the art that various modifications and alternatives to those details could be developed in light of the overall teachings of the disclosure and the broad inventive concepts thereof. It is understood, therefore, that the scope of this disclosure is not limited to the particular examples and implementations disclosed herein but is intended to cover modifications within the spirit and scope thereof as defined by the appended claims and any and all equivalents thereof.

What is claimed as new and desired to be protected by Letters Patent of the United States is:

1. A system for monitoring the temperature of a vehicle, the system comprising:
a device body;
a microprocessor housed in the device body;
a temperature sensor in the device body connected to the microprocessor;
a transmitter in the device body connected to the microprocessor, the microprocessor executing code to monitor ambient temperature with the temperature sensor and when the ambient temperature exceeds a preset level sending a message using the transmitter to a mobile electronic device.

2. The system of claim 1, wherein the transmitter utilizes Wi-Fi Direct protocol.

3. The system of claim 1, wherein the transmitter utilizes GSM protocol.

4. The system of claim 3, wherein the message is a text message.

5. The system of claim 1, wherein the mobile electronic device is a smart phone.

6. The system of claim 1, further comprising a battery located in the device body.

7. The system of claim 6, further comprising a plug for interfacing with a power source of the vehicle, the power source providing for charging of the battery, the microprocessor executing instructions to control the charging of the battery.

8. The system of claim 7, wherein the power source is a standard 12V vehicle receptacle.

9. A system for monitoring the temperature of a vehicle, the system comprising:
a device including:
a device body;
a microprocessor housed in the device body;
a temperature sensor in the device body connected to the microprocessor;
a transmitter in the device body connected to the microprocessor;
a mobile electronic device, the mobile electronic device communicating with the transmitter and microprocessor, the microprocessor executing code to monitor ambient temperature with the temperature sensor and when the ambient temperature exceeds a preset level sending a message using the transmitter to the mobile electronic device.

10. The system of claim 9, wherein the mobile electronic device is executing code enabling the mobile electronic device to configure the preset level via the transmitter.

11. The system of claim 9, wherein the mobile electronic device is executing code that mates the mobile electronic device to the device.

12. The system of claim 11, wherein the mating involves programming a phone number of the mobile electronic device in the device.

13. The system of claim 9, wherein the transmitter utilizes Wi-Fi Direct protocol.

14. The system of claim 9, wherein the message is sent via Wi-Fi Direct protocol directly to the mobile electronic device and the mobile electronic device is executing code causing the mobile electronic device to produce a notification for the user based on receiving the message.

15. The system of claim 9, wherein the transmitter utilizes GSM protocol.

16. The system of claim 15, wherein the message is a text message.

17. The system of claim 9, wherein the mobile electronic device is a smart phone.

18. The system of claim 9, further comprising a battery located in the device body.

19. The system of claim 18, further comprising a plug for interfacing with a power source of the vehicle, the power source providing for charging of the battery, the microprocessor executing instructions to control the charging of the battery.

20. The system of claim 19, wherein the power source is a standard 12V vehicle receptacle.
